(19) United States
(12) Patent Application Publication
(10) Pub. No.: US 2023/0353020 A1
(43) Pub. Date: Nov. 2, 2023

(54) ELECTRIC DRIVE SYSTEM

(71) Applicant: UT-Battelle, LLC, Oak Ridge, TN (US)

(72) Inventors: Md S. Chowdhury, Oak Ridge, TN (US); Tsarafidy Raminosoa, Oak Ridge, TN (US); Burak Ozpineci, Oak Ridge, TN (US); Randy H. Wiles, Oak Ridge, TN (US); Emre Gurpinar, Oak Ridge, TN (US); Gui-Jia Su, Oak Ridge, TN (US); Jason L. Pries, Oak Ridge, TN (US)

(21) Appl. No.: 17/733,251

(22) Filed: Apr. 29, 2022

(51) Int. Cl. H02K 11/33; H02K 7/00; H02K 5/22

(52) U.S. Cl. CPC H02K 11/33; H02K 7/003; H02K 5/225

(57) ABSTRACT

An electric drive system is provided where the inverter may be integrated within the motor. The electric drive system may include an outer rotor and an inner stator, where the inner stator includes an interior space in which circuitry for the electric drive system may be provided.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF INVENTION

The present disclosure relates to the field of electric drive systems or excitation systems, and more particularly toward an electric drive system including integrated circuitry.

### BACKGROUND

In a conventional electric motor drive, both the motor and the inverter are manufactured independently. As a result, a large volume is required to accommodate the electric drive unit. These types of drive units also suffer from higher switching losses and large voltage overshoot due to the inductance of long wires provided between the motor and the inverter. Space restrictions may affect size constraints for electric drive units, particularly in applications such as electric vehicle traction and more electric aircraft.

There are several conventional forms of integrated motor drives available in the market that attempt to comply with application space constraints. Conventional forms of integrated motor drives, also described as integrated electric drive units, utilize physical integration of all of the parts of the electric drive unit in a single casing in an effort to reducing volume, cost, and complexity of installation.

There are several types of conventional integrated electric drive systems. These include a radial housing mount configuration, where the inverter is manufactured in a separate casing and then mounted on top of the motor casing. This type of integration may lower power density due to the geometry, additional casing, and use of busbars. Another conventional version of the radial mounting inverter system utilizes the outer periphery of the motor. In this type of integration, the inverter and the motor may share the same cooling system. Two other conventional integrated configurations involve an axially mounted inverter, where the inverter is either directly mounted to an endplate of the motor, or the inverter is mounted in between the stator lamination and the endplate. The latter suffers from an extreme environment as the inverter is mounted next to the major heat source (i.e., the stator winding).

### SUMMARY

In general, one innovative aspect of the subject matter described herein can be embodied in an excitation system comprising a stator including a stator winding and a stator core, and a stator support operable to maintain the stator in a fixed position. The stator support may include an internal space, and an integrated inverter circuit system may be arranged inside the internal space. The excitation system may include a rotating shaft configured to rotate relative to the stator during operation of the excitation system, and a rotor coupled to the rotating shaft to rotate along with the rotating shaft. The rotor may include a plurality of permanent magnets arranged concentric with the stator about a longitudinal axis of the excitation system, and the rotor may be spaced farther from the longitudinal axis than the stator such that the rotor is outside the stator.

The foregoing and other embodiments can each optionally include one or more of the following features, alone or in combination. In particular, one embodiment includes all the following features in combination.

In some embodiments, the rotor may include an outer sleeve with an interior sleeve surface, where the plurality of permanent magnets are coupled to the interior sleeve surface of the outer sleeve.

In some embodiments, the outer sleeve may be ferromagnetic.

In some embodiments, the excitation system may include a housing operable to support first and second bearings, where the first and second bearings are spaced apart along the longitudinal axis. The rotor support may be operably coupled to the rotor, and may include the rotating shaft such that the rotor support is configured to rotate along with the rotor. The rotating shaft may be supported by the first bearing, where a rotor bearing support of the rotor support is operably interfaced to the second bearing, and wherein the rotating shaft and the rotor bearing support are operable, in conjunction with the first and second bearings, to maintain alignment of the rotor support relative to the stator.

In some embodiments, the excitation system may include a stationary shaft coupled to the stator support and the housing, where the stationary shaft covers the internal space of the stator support.

In some embodiments, the rotating shaft may be hollow and may provide access to the stator support.

In some embodiments, the internal space of the stator support may define an interior surface of the stator support that is cylindrical and coaxial with the longitudinal axis. A heat sink may be disposed within the internal space of the stator support and in contact with the interior surface of the internal space. The heat sink may include a heat sink interior space that extends along the longitudinal axis. The heat sink interior space may define a heat sink interior surface of the heat sink that extends along the longitudinal axis.

In some embodiments, the integrated inverter circuit system may be disposed within the heat sink interior space and in contact with the heat sink interior surface to facilitate heat transfer from the integrated inverter circuit system to the heat sink.

In some embodiments, the excitation system may include a plurality of power modules that together form the integrated inverter circuit system, where each of the plurality of power modules may be disposed in contact with the heat sink interior surface such that the heat sink is shared by the plurality of power modules.

In some embodiments, the heat sink may provide a cold-plate that is actively cooled by a cooling system.

In some embodiments, the excitation system is a traction drive system operable to provide motive power for a vehicle.

In some embodiments, the integrated inverter circuit system includes a power module with switching circuitry and gate drive circuitry operably coupled to the switching circuitry, where the switching circuitry may be operably directed by the gate drive circuitry to supply power to the stator winding to facilitate rotational motion of the rotor relative to the stator.

In general, one innovative aspect of the subject matter described herein can be embodied in an excitation system including a stator with a stator winding and a stator core, and a rotating shaft configured to rotate relative to the stator during operation of the excitation system. The rotating shaft may be coaxial with a longitudinal axis of the excitation system. The excitation system may include a stator support operable to maintain the stator in a fixed position, where the stator support may include an internal space, where internal space may encompass at least a portion of the longitudinal axis of the excitation system. The excitation system may include a rotor coupled to the rotating shaft, where the rotor may include a plurality of permanent magnets. The excitation system may include an integrated inverter system at least partially disposed within the internal space, and a heat sink may be provided to dissipate heat generated by at least one of the stator and the integrated inverter system. At least a portion of the heat sink may be disposed within the internal space of the stator.

The foregoing and other embodiments can each optionally include one or more of the following features, alone or in combination. In particular, one embodiment includes all the following features in combination.

In some embodiments, the rotor may be coupled to the rotating shaft to rotate along with the rotating shaft, where the rotor may be concentric with the stator about the longitudinal axis of the excitation system, and where the rotor may be spaced farther from the longitudinal axis than the stator such that the rotor is outside the stator.

In some embodiments, the rotor may include an outer sleeve with an interior sleeve surface, where the rotor may include a plurality of magnets coupled to the interior sleeve surface of the outer sleeve.

In some embodiments, the outer sleeve may be ferromagnetic.

In some embodiments, the excitation system may include a housing operable to support first and second bearings, where the first and second bearings may be spaced apart along the longitudinal axis. The excitation system may include a rotor support operably coupled to the rotor and including the rotating shaft. The rotor support may be configured to rotate along with the rotor, and the rotating shaft may be supported by the first bearing. A rotor bearing support of the rotor support may operably interfaced to the second bearing. The rotating shaft and the rotor bearing support may be operable, in conjunction with the first and second bearings, to maintain alignment of the rotor support relative to the stator.

In some embodiments, the integrated inverter system may be disposed inside the excitation system, where the integrated inverter system may include a power module with switching circuitry and gate drive circuitry operably coupled to the switching circuitry. The switching circuitry may be operably directed by the gate drive circuitry to supply power to the stator winding to facilitate rotational motion of the rotor relative to the stator.

In some embodiments, the internal space of the stator support may define an interior surface of the stator support that is cylindrical and coaxial with the longitudinal axis. The heat sink may be disposed within the internal space of the stator support and in contact with the interior surface of the internal space. The heat sink may include a heat sink interior space that extends along the longitudinal axis. The heat sink interior space may define a heat sink interior surface of the heat sink that extends along the longitudinal axis.

The integrated inverter system may be disposed within the heat sink interior space and in contact with the heat sink interior surface to facilitate heat transfer from the integrated inverter system to the heat sink.

In some embodiments, the internal space may define an interior surface of the stator support that is cylindrical and coaxial with the longitudinal axis of the excitation system.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows an electric drive system in accordance with one embodiment.

FIG. 2 shows a rotor and stator configuration in accordance with one embodiment.

FIG. 3 shows a cross-sectional view of an electric drive system in FIG. 1.

FIG. 4 shows a cross-sectional view of the power electronic casing inside the motor, the cylindrical space in FIG. 3.

FIG. 5 shows an integrated power converter in accordance with one embodiment.

FIG. 6 depicts a power module in accordance with one embodiment.

FIG. 7 shows a gate driver integrated with the power module in accordance with one embodiment.

FIG. 8 shows a cross-sectional view of the electric drive system in accordance with one embodiment.

FIG. 9 shows a cross-sectional view of the electric drive system in FIG. 8.

### DETAILED DESCRIPTION

In one embodiment, an electric drive system is provided where the inverter may be integrated within the motor. The electric drive system may include an outer rotor and an inner stator, where the inner stator includes an interior space in which circuitry for the electric drive system may be included. This construction may enable incorporation of integrated circuitry in the electric drive system while keeping the overall volume equal to or substantially the same as the motor volume. As a result, the power density of the electric drive system may be increased significantly over conventional integrated electric drives. In one embodiment of the electric drive system, the distance between the inverter and motor may be reduced or minimized such that substantial adverse effects due to cable length between the inverter and the motor may be avoided. Such adverse effects include electromagnetic interference and voltage overshoot at motor terminals.

In one embodiment, the elimination of a separate casing can enable elimination of or a reduction in busbars and long wires, and can enable sharing of the cooling system.

As described herein, in one embodiment, overall power density of an integrated electric drive can be increased relative to conventional offerings by integrating the inverter within the motor assembly without significantly affecting motor volume. To allow this tight integration, an outer rotor motor may be provided. The outer rotor motor may provide a stationary hollow cylindrical space within the motor assembly, thus allowing integration of the inverter within the motor to yield high power density. The structure of the drive unit in the electrical drive system may be configured for high power density by utilizing space within an outer rotor motor configuration. This may be useful for space-restricted applications, such as automotive traction applications or electric aircraft. The electrical drive system may be incorporated into any type of motor or generator application.

In one embodiment, the electric drive system may include a heat sink (e.g., in the form of a cold plate) that can be shared by the integrated inverter circuitry and the stator of the electric drive system. For instance, an outer surface of the heat sink may be in thermal communication (e.g., in contact) with the stator, and an inner surface of the heat sink may be in thermal communication (e.g., in contact) with the integrated inverter circuitry. As described herein, the integrated inverter circuitry may include a plurality of modules; it is to be understood that the heat sink may be shared by more than one of such a plurality of modules.

The electrical drive system in one embodiment may provide a three or multiphase outer rotor motor configuration, with the integrated inverter circuitry being configured accordingly. The electrical drive system may be configured to deliver up to 100 kW peak power and may operate at speeds up to 20 kRPM. However, it should be understood that the present disclosure is not so limited to such power output or speed. The electrical drive system may be configured for any power output or speed, or both.

In one embodiment, the outer rotor of the electrical drive system may include permanent magnets. The structure of the outer rotor motor may enable, for a given volume, an airgap diameter of the outer rotor motor and may be greater than the air gap diameter for a conventional inner rotor motor configuration. This increase in airgap diameter increases the rotor surface area for energy conversion and as a result, yields greater torque density.

In one embodiment, the outer rotor construction may include a rotor backing (e.g., an iron or iron-based backing) that provides inherent mechanical retention of rotor magnets against outward centrifugal force at high rotational speeds. As a result, additional sleeves used in conventional constructions can be eliminated (thus losses in the sleeve are eliminated), and the air gap between stator and rotor can be reduced or minimized.

In one embodiment, the construction of the outer rotor motor may be configured such that a hollow space may be provided within the stator. In this hollow space or interior space, integrated circuitry may be provided. For instance, interior space may enable integrating the inverter within the motor without substantially affecting the motor volume. This way, the overall motor and power converter volume may be significantly reduced.

In one embodiment, to utilize the interior space provided within an inner stator construction, a SiC-based single-phase power module may be constructed. For instance, a direct bonded copper (DBC) structure may be provided for the power module. A gate driver PCB and decoupling capacitor board may be constructed for operation of and volume reduction of the power module. In one embodiment, a hexagonal shaped cold plate, which may correspond to one embodiment of a heat sink, may be constructed to accommodate more than one power module (e.g., six modules). This heat sink may facilitate maintaining the power module within its operating temperature, and may substantially protect the power modules from excessive stator heat (e.g., the stator winding may go up to 200 C and some inverter components are limited to 150 C). As described herein, the interior space may accommodate a plurality of power modules, e.g., six modules, and with additional space available for additional components.

I. Overview

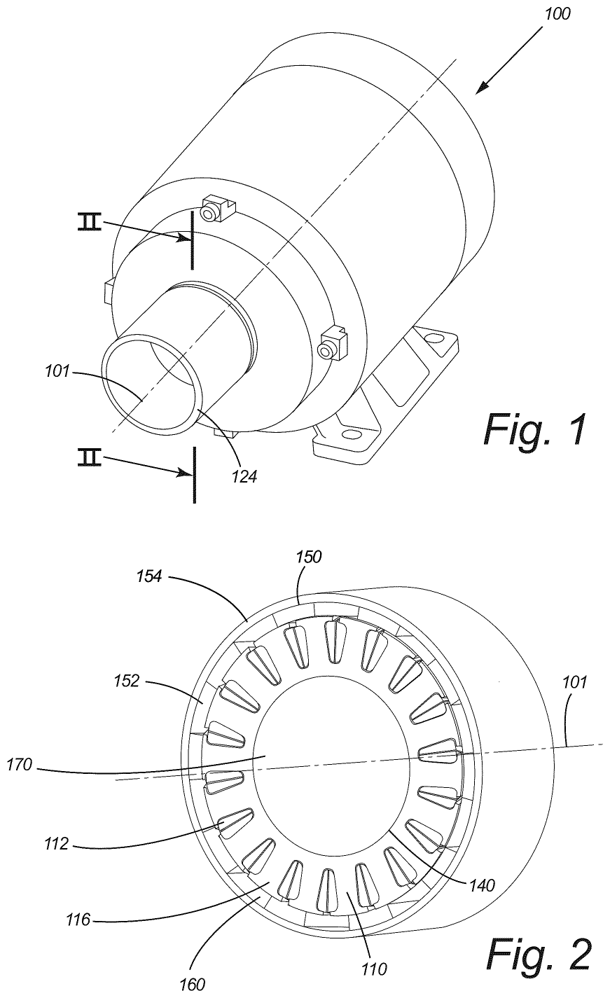

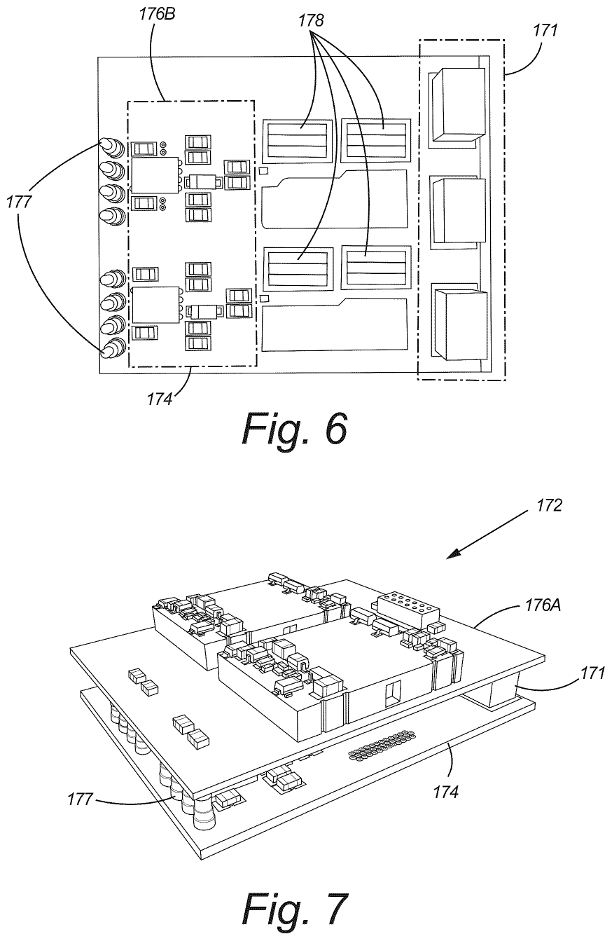

An electric drive system 100 (also described herein as an electric excitation system) in accordance with one embodiment is shown in FIGS. 1-6 and includes integrated circuitry, such as an integrated inverter system 170, which may include circuitry arranged within an internal space of the electric drive system 100. It is to be understood that a portion of the integrated inverter system 170 may be outside the internal space of the electric drive system 100.

The electric drive system 100 may include a stator 110 that is stationary with respect to a rotor 150, which is outside the stator 110. The electric drive system 100 may include a shaft 124 configured to rotate relative to the stator 110 during operation, and the rotor 150 may be affixed to or coupled to the shaft 124, such that the rotor 150 and shaft 124 rotate together during operation. In the illustrated embodiment, the rotor 150 and the shaft 124 rotate about a longitudinal axis 101 of the electric drive system 100.

In the illustrated embodiment of FIGS. 1-2, the electric drive system 100 includes a rotor 150 that is spaced apart from the stator 110 by a gap 160. The gap 160 (which may be a predetermined airgap) may facilitate rotation of the rotor 150 relative to the stator 110 while enabling effective excitation for purposes of generating electro-motive force or electrical energy, depending on whether the construction is configured as a generator or a motor. The size of the gap 160 may vary from application to application, and may be 2 mm-3 mm as an example.

In the illustrated embodiment, the electric drive system 100 may be constructed such that the rotor 150 is an outer rotor construction. The rotor 150 may be spaced farther from the longitudinal axis 101 then the stator 110 such that the rotor 150 is outside the stator 110.

The rotor 150 may include a rotor backing 154 and a plurality of permanent magnets 152 that facilitate operation. The rotor backing 154 may be a sleeve operable to support the plurality permanent magnets 152 as the rotor backing 154 and the plurality of permanent magnets 152 rotate about the longitudinal axis 101.

The stator 110 in the illustrated embodiment is stationary and arranged closer to the longitudinal axis 101 than the rotor 150. The stator 110 may include a winding assembly 112 and a core 116. The winding assembly 112, as described herein, may include a plurality of windings, one or more of which may be electrically isolated from each other.

The stator 110 in the illustrated embodiment includes an internal space 140 that may be configured to accommodate integrated circuitry or other components of the electric drive system 100. For instance, power electronics, such as components of the integrated inverter system 170, may be arranged or disposed within the internal space 140 of the stator 110. Additional examples of components arranged or disposed within the internal space 140 include a heat sink, such as the heatsink 180 described herein.

In the illustrated embodiment, the rotor 150 and the stator 110 are concentric with respect to each other about the longitudinal axis 101 with the rotor 150 being outside the stator 110. The internal space 140, as can be seen in the illustrated embodiment of FIG. 2, encompasses at least a portion of the longitudinal axis 101 of the electric drive system 100.

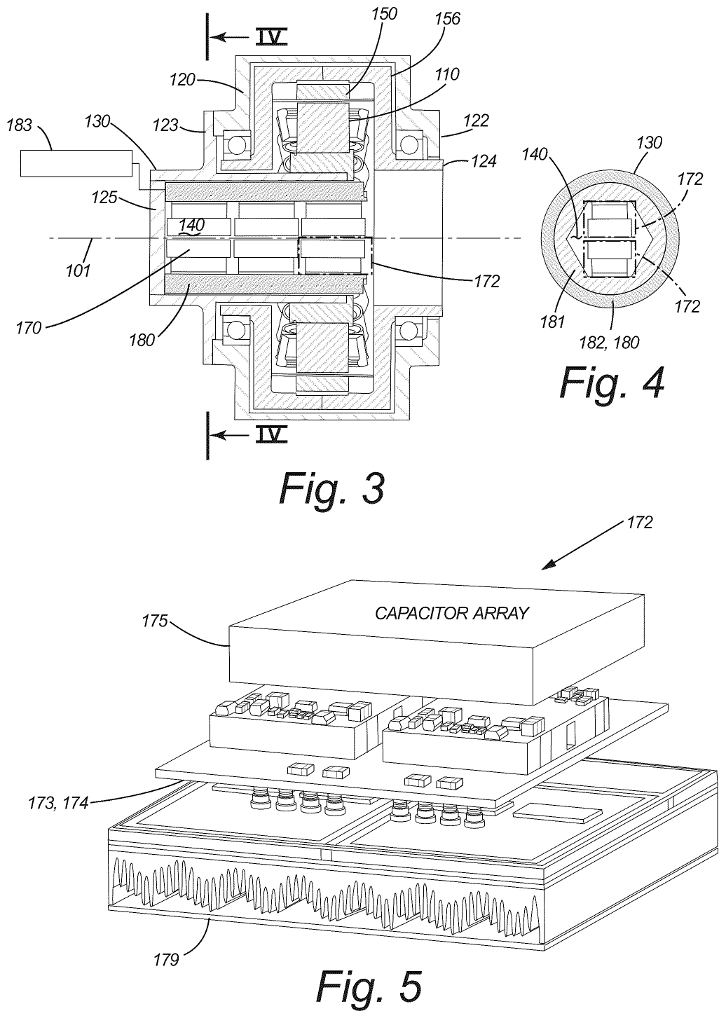

In the illustrated embodiment of FIGS. 3 and 4, the electric drive system 100 is shown in further detail, including the rotor 150 and the stator 110 arrangement. The rotor 150 may be coupled to a support 156 operable to maintain a position of the rotor 150 relative to the stator 110 (e.g., to substantially maintain the gap 160). The support 156 may rotate along with the rotor 150 within a housing 120 of the electric drive system 100. The housing 120 (e.g., an aluminum housing) may be provided to enclose the rotor 150, the stator 110, and the integrated inverter system 170. The rotor 150 may be concentric with respect to the stator 110 about the longitudinal axis 101, with the rotor 150 being farther from the longitudinal axis 101 than the stator 110 such that the rotor 150 is outside the stator 110.

In one embodiment, the support 156 may be integrated with or coupled as a separate component to the shaft 124. A first bearing 122 may be disposed on the shaft 124 and interface with the housing 120 to facilitate maintaining a position of the rotor 150 and shaft 124 relative to the stator 110. A second bearing 123 may interface with the housing 120 and the support 156 to facilitate maintaining the position of the rotor 150 and the shaft 124 relative to the stator 110.

The rotor 150 in the illustrated embodiment may include a rotor backing 154, such as a sleeve, which may be formed of metal or another type of material, or a combination of materials. The rotor backing 154 may support a plurality of magnets 152 (e.g., surface mount permanent magnets) arranged to interact with the stator 110 to generate electro motive force or to generate electrical energy in the stator 110. The rotor backing 154 in the illustrated embodiment is a ferrite based backing (e.g., iron) arrangement for supporting the plurality of magnets 152 while the plurality of magnets 152 rotate along with the shaft 124. The rotor backing 154 may be configured to support the plurality of magnets 152 in rotation at high speed, such as RPMs greater than 10,000 RPM, or 20,000 RPM, for example.

The support 156 in one embodiment may be a nonconductive and nonmagnetic material. The support 156 may be operable to maintain a position of the rotor 150 relative to the stator 110. The material used for the support 156 may vary from application to application, including composite materials based on glass fiber or carbon fiber, G11, BME, thermoplastic, ceramic, and/or cermet. The construction of the support 156 may provide a mechanically strong, nonconductive and nonmagnetic material in one embodiment to facilitate high-speed operation.

The support 156 in one embodiment may be conductive and optionally magnetic. For instance, the support 156 may be integral to the shaft 124, which may be specified for an application as being steel. Because the shaft 124 and support 156 are integral in this arrangement, the support 156 may also be constructed of steel. The steel shaft 124 and support 156 may be heat-treated to enhance hardness and distortion of high-speed and temperature.

The shaft 124 may vary in construction from application to application. For instance, the shaft 124 may be metallic material (e.g., stainless steel) in one embodiment, whereas in another embodiment, the shaft 124 may be nonconductive material. As another example, the shaft 124 may be nonmagnetic in addition to or alternative to being a metallic material or a nonconductive material.

The stator 110 in the illustrated embodiment includes a core 116 and a winding assembly 112 operable to facilitate generation of flux for generating torque with respect to the rotor 150. Alternatively, in configurations where the electric drive system 100 is a type of excitation system that operates as a generator, the core 116 and the winding assembly 112 may operate to generate electrical current in response to flux imparted on the stator 110 by the rotor 150.

The core 116 in the illustrated embodiment may be constructed of a ferromagnetic material, such as an iron-based construction. The core 116 may be solid or formed of laminated plates. The lamination plates may reduce eddy current losses in the core and may enhance overall motor efficiency.

The winding assembly 112 may be constructed of motor wire, such as Litz wire, having a number of strands and gauge determined according to target operational parameters of the electric drive system 100. Additional example wire configurations include insulated single strand wire, hairpin winding, etc.

The electrical drive system 100 illustrated embodiment includes a stator support 130 operable to support the stator 110 in position relative to the rotor 150 during operation. The stator support 130 is stationary, similar to the stator 110, and in the illustrated embodiment may be coupled to the housing 120 while forming at least a portion of the exterior of the electric drive system 100.

The stator support 130 in the illustrated embodiment defines an internal space 140 in which the integrated inverter system 170, or any type of circuitry, may be disposed within the electric drive system 100. The stator support 130 may be constructed of a variety of materials, depending on a variety of parameters associated with the electric drive system 100, such as thermal conductivity and structural rigidity.

The internal space 140 can be seen in further detail in FIG. 4 with the stator support 130 having an internal surface that defines the internal space 140. The internal surface of the stator support 130 may be cylindrical, with a smooth annular cross-section or a polygon-based multi-faceted cross-section. The cylindrical surface may have a regular cross-section (e.g., all-sides equal in length) or an irregular cross-section (e.g., at least two different length sides).

A heatsink 180 may be disposed in contact with the internal surface of the stator support 130. The heatsink 180 may be configured to facilitate dissipation of heat from the integrated inverter system 170. The heatsink 180 in conjunction with a heatsink interface 182 may define a heat sink internal space 181 in which the integrated inverter system 170 may be disposed and mounted. For instance, the integrated inverter system 170, as described herein, may include a plurality of power modules 172. Each of the plurality of power modules may be mounted to the heatsink interface 182 for supporting the power module 172 within the heat sink internal space 181. The heatsink interface 182 is shown in the illustrated embodiment as being integral with the heatsink 180; however, the heatsink interface 182 and the heatsink 180 may be separate in an alternative embodiment, such as the in the illustrated embodiment of FIG. 9.

The heatsink 180 in the illustrated embodiment is a shared heatsink with respect to multiple circuit assemblies of the integrated inverter system 170, such as the plurality of power modules 172 of the integrated inverter system 170. The heatsink 180 in one embodiment may be coupled to a cooling system 183 operable to exchange coolant with the heatsink 180. For example, the cooling system 183 may supply liquid coolant to the heatsink 180 via a supply coupling with the heatsink 180, and the cooling system 183 may receive liquid coolant back from the heatsink 180 via a return coupling with the heatsink 180. Additionally, or alternatively, the cooling system 183 may be coupled to one or more heatsinks separate from the heatsink 180 and associated with circuitry of the integrated inverter system 170, such as power modules 172. For instance, each power module 172 may include a heatsink separate from the heatsink 180, and the cooling system 183 may interface with such a separate heatsink. More specifically, the separate heatsink for one or more power modules 172 may be a liquid-based heatsink that is operable to exchange liquid coolant with the cooling system 183.

In the illustrated embodiment, the heatsink 180 is shared by the integrated inverter system 170 and the stator 110, such that the heatsink 180 is operable to dissipate thermal energy from both the integrated inverter system 170 and the stator 110. The heatsink 180 may be actively cooled to facilitate such thermal dissipation of heat from the integrated inverter system 170 and the stator 110.

In the illustrated embodiment, the shaft 124 of the electric drive system 100 includes a central opening aligned coaxially with the longitudinal axis 101 that provides access to the internal space 140 of the electric drive system 100. Depending on the configuration, optionally, the central opening may be utilized for wiring or coupling to a cooling system 183, or both. The central opening may provide access for air flow in one embodiment that further facilitates cooling of the integrated inverter system 170 and/or the stator 110.

The integrated inverter system 170 in the illustrated embodiment of FIGS. 3 and 4 is arranged such that each power module 172 is disposed either on an upper or lower portion of the heatsink 180. It is to be understood that the integrated inverter system 170 may be arranged differently within the internal space 140.

In the illustrated embodiment, an end cap 125 is provided to cover the internal space 140 in which the integrated inverter system 170 may be disposed. The end cap 125 may be considered a stationary shaft in accordance with one embodiment. The end cap 125 may be removed for access to the integrated inverter system 170, and may optionally include one or more apertures or notches that facilitate access to the integrated inverter system 170 or the heatsink 180, or both. As an example, the end cap 125 may provide access for wiring in order to connect the integrated inverter system 170 to a power supply. As another example, the end cap 125 may provide access to coolant lines associated with the cooling system 183. In an alternative embodiment, the end cap 125 may be absent.

II. Integrated Circuitry

As described herein, the electric drive system 100 may include integrated circuitry disposed within a motor unit of the electric drive system 100. The integrated circuitry may correspond to integrated inverter system 170 that includes one or more power modules 172 operable to supply power to the winding 112 of the stator 110. The winding assembly 112 may include a plurality of separate windings, each of which may be coupled to one or more of the power modules 172. The one or more power modules 172 may operate in conjunction with each other to supply power to the plurality of windings of the winding assembly 112 to facilitate generation of flux.

A power module 172 in accordance with one embodiment is shown in FIGS. 5-7 and includes a main module 174 that provides switching circuitry 178 and gate control circuitry 176B for controlling operation of the switching circuitry 178. The main module 174 may include a plurality of power connectors 171 operable to receive power from an external power supply and to supply power output from the switching circuitry 178, where the power open from the circuitry 170 is based on the power received from the external power supply. The main module 174 may include a plurality of inter-module connectors 177 operable to interface with a gate control module 173, which may include gate control circuitry 176A. The gate control circuitry 176A of the gate control module 173 may operate in conjunction with the gate control circuitry 176B of the main module 174 to control operation of the switching circuitry 178.

In one embodiment, the gate control module 173 may be configured for coordinated operation of the switching circuitry 178 in conjunction with switching circuitry 178 of another power module 172. For instance, the power modules 172 may coordinate with each other to supply power to the plurality of windings of the winding assembly 112 to facilitate generation of flux. As another example, a controller or control system disposed on one of the power modules 172 or separately from the power modules 172 may control operation of the power modules 172 to supply power to the winding assembly 112 of the stator 110 in order to generate torque.

The power module 172 may include a capacitor array 175 provided separate from the main module 174 and the gate control module 173. The capacitor array 175 may be configured to provide both a target capacitance and a form factor that fits within the available space of the internal space 140 of the stator 110.

The power module 172 in the illustrated embodiment includes a power module heat sink 179 operable to facilitate dissipation of heat generated by respective power module 172. The power module heat sink 179 may be thermally coupled to the heatsink 180 of the electric drive system 100. Alternatively, the power module heat sink 179 may not be thermally coupled to the heat sink 180—e.g., the power module heat sink 179 may be coupled to one side of the power module 172 and the heatsink 180 may be coupled to the other side of the power module 172.

The power module heat sink 179 may vary from application to application. In one embodiment, the power module heat sink 179 may be liquid cooled. For instance, the power module heat sink 179 may be a liquid cooled heat sink in accordance with one embodiment described in U.S. application Ser. No. 17/495,098, entitled HEAT SINK SYSTEM, filed Oct. 6, 2021, to Sahu et al.—the disclosure of which is hereby incorporated by reference in its entirety. Cooling via a coolant (e.g., a liquid or any type of fluid coolant, including gas) may be controlled by a cooling system 183 operable to supply and receive the coolant.

III. Alternative Electrical Drive System

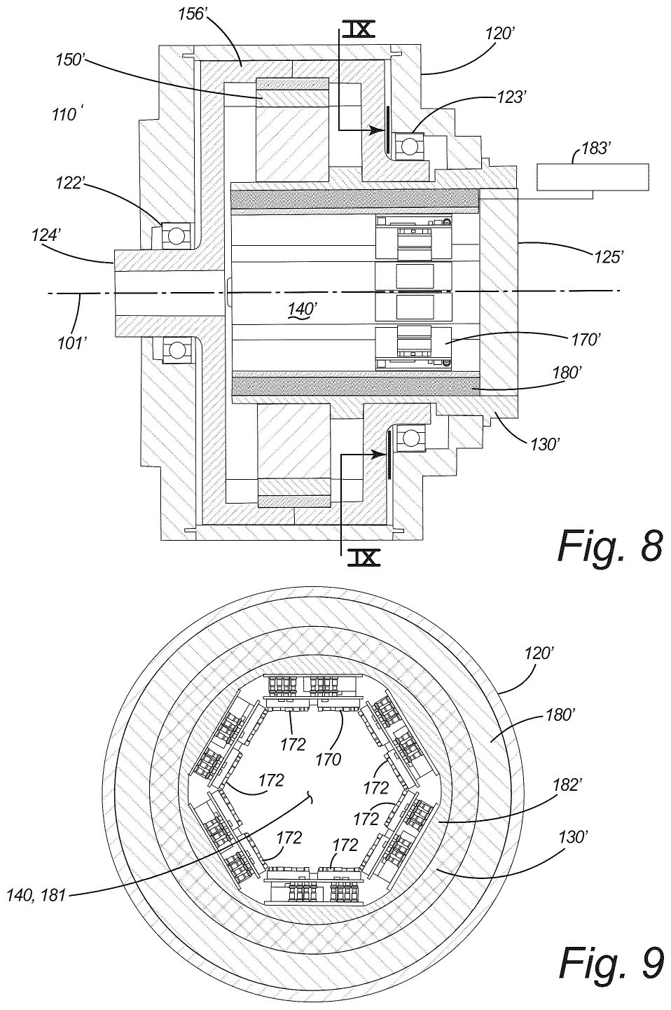

In the illustrated embodiments of FIGS. 8 and 9, an electric drive system 100′ is depicted in a configuration similar in some respects to the electric drive system 100. For purposes of disclosure, parts of the electric drive system 100′ that are similar in name to parts of the electric drive system 100 are designated by reference numbers that share the same digits along with the addition of a “′” designation.

The electric drive system 100′ includes integrated circuitry, such as an integrated inverter system 170′, and a stator 110′ that is stationary with respect to a rotor 150′, which is arranged outside the stator 110′. The electric drive system 100′ may include a shaft 124′ configured to rotate relative to the stator 110′ during operation. The rotor 150′ may be affixed to or coupled to the shaft 124′, such that the rotor 150′ and shaft 124′ rotate together during operation. In the illustrated embodiment, the rotor 150′, the shaft 124′, and the stator 110′ rotate about a longitudinal axis 101′ of the electric drive system 100′.

The electric drive system 100′ is similar in many respects to the electric drive system 100. The primary difference is the shaft 124′ in the electric drive system 100′ includes a central opening aligned coaxially with the longitudinal axis 101 that provides less access to the internal space 140′ of the electric drive system 100′.

As can be seen in FIG. 9, the construction of the power module interface 182′ and the arrangement of the power modules 172′ is different from the arrangement in the electric drive system 100. The power modules 172′ are disposed on each side of the interior, cylindrical surface of the power module interface 182, with the power module interface 182 providing the primary thermal interface between the power modules 172′ and the heatsink 180′, which is shared with the stator 110.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An excitation system comprising:
a stator including a stator winding and a stator core,
a stator support operable to maintain the stator in a fixed position, the stator support including an internal space;
an integrated inverter circuit system arranged inside the internal space;
a rotating shaft configured to rotate relative to the stator during operation of the excitation system; and
a rotor coupled to the rotating shaft to rotate along with the rotating shaft, the rotor including a plurality of permanent magnets arranged concentric with the stator about a longitudinal axis of the excitation system, the rotor being spaced farther from the longitudinal axis than the stator such that the rotor is outside the stator.

2. The excitation system of claim 1 wherein the rotor includes an outer sleeve with an interior sleeve surface, and wherein the plurality of permanent magnets are coupled to the interior sleeve surface of the outer sleeve.

3. The excitation system of claim 2 wherein the outer sleeve is ferromagnetic.

4. The excitation system of claim 1 comprising:
a housing operable to support first and second bearings, the first and second bearings spaced apart along the longitudinal axis;
a rotor support operably coupled to the rotor, the rotor support including the rotating shaft and configured to rotate along with the rotor;
wherein the rotating shaft is supported by the first bearing;
wherein a rotor bearing support of the rotor support is operably interfaced to the second bearing; and
wherein the rotating shaft and the rotor bearing support are operable, in conjunction with the first and second bearings, to maintain alignment of the rotor support relative to the stator.

5. The excitation system of claim 4 comprising a stationary shaft coupled to the stator support and the housing, the stationary shaft covering the internal space of the stator support.

6. The excitation system of claim 4 wherein the rotating shaft is hollow and provides access to the stator support.

7. The excitation system of claim 1 wherein:
the internal space of the stator support defines an interior surface of the stator support that is cylindrical and coaxial with the longitudinal axis;
a heat sink is disposed within the internal space of the stator support and in contact with the interior surface of the internal space;
the heat sink includes a heat sink interior space that extends along the longitudinal axis; and
the heat sink interior space defines a heat sink interior surface of the heat sink that extends along the longitudinal axis.

8. The excitation system of claim 7 wherein the integrated inverter circuit system is disposed within the heat sink interior space and in contact with the heat sink interior surface to facilitate heat transfer from the integrated inverter circuit system to the heat sink.

9. The excitation system of claim 7 comprising a plurality of power modules that together form the integrated inverter circuit system, wherein each of the plurality of power modules is disposed in contact with the heat sink interior surface such that the heat sink is shared by the plurality of power modules.

10. The excitation system of claim 7 wherein the heat sink provides a cold-plate that is actively cooled by a cooling system.

11. The excitation system of claim 1 wherein the excitation system is a traction drive system operable to provide motive power for a vehicle.

12. The excitation system of claim 1 wherein the integrated inverter circuit system includes a power module with switching circuitry and gate drive circuitry operably coupled to the switching circuitry, the switching circuitry being operably directed by the gate drive circuitry to supply power to the stator winding to facilitate rotational motion of the rotor relative to the stator.

13. An excitation system comprising:
a stator including a stator winding and a stator core,
a rotating shaft configured to rotate relative to the stator during operation of the excitation system, the rotating shaft being coaxial with a longitudinal axis of the excitation system;
a stator support operable to maintain the stator in a fixed position, the stator support including an internal space, the internal space encompassing at least a portion of the longitudinal axis of the excitation system;
a rotor coupled to the rotating shaft, the rotor including a plurality of permanent magnets;
an integrated inverter system at least partially disposed within the internal space; and
a heat sink provided to dissipate heat generated by at least one of the stator and the integrated inverter system, at least a portion of the heat sink being disposed within the internal space of the stator.

14. The excitation system of claim 13 comprising the rotor coupled to the rotating shaft to rotate along with the rotating shaft, the rotor being concentric with the stator about the longitudinal axis of the excitation system, the rotor being spaced farther from the longitudinal axis than the stator such that the rotor is outside the stator.

15. The excitation system of claim 14 wherein the rotor includes an outer sleeve with an interior sleeve surface, and wherein the rotor includes a plurality of magnets coupled to the interior sleeve surface of the outer sleeve.

16. The excitation system of claim 15 wherein the outer sleeve is ferromagnetic.

17. The excitation system of claim 14 comprising:
a housing operable to support first and second bearings, the first and second bearings spaced apart along the longitudinal axis;
a rotor support operably coupled to the rotor, the rotor support including the rotating shaft and configured to rotate along with the rotor;
wherein the rotating shaft is supported by the first bearing;
wherein a rotor bearing support of the rotor support is operably interfaced to the second bearing; and
wherein the rotating shaft and the rotor bearing support are operable, in conjunction with the first and second bearings, to maintain alignment of the rotor support relative to the stator.

18. The excitation system of claim 14 wherein the integrated inverter system is disposed inside the excitation system, and wherein the integrated inverter system includes a power module with switching circuitry and gate drive circuitry operably coupled to the switching circuitry, the switching circuitry being operably directed by the gate drive circuitry to supply power to the stator winding to facilitate rotational motion of the rotor relative to the stator.

19. The excitation system of claim 13 wherein:
the internal space of the stator support defines an interior surface of the stator support that is cylindrical and coaxial with the longitudinal axis;
the heat sink is disposed within the internal space of the stator support and in contact with the interior surface of the internal space;
the heat sink includes a heat sink interior space that extends along the longitudinal axis;
the heat sink interior space defines a heat sink interior surface of the heat sink that extends along the longitudinal axis; and
the integrated inverter system is disposed within the heat sink interior space and in contact with the heat sink interior surface to facilitate heat transfer from the integrated inverter system to the heat sink.

20. The excitation system of claim 13 wherein the internal space defines an interior surface of the stator support that is cylindrical and coaxial with the longitudinal axis of the excitation system.
